(19) United States
(12) Patent Application Publication
(10) Pub. No.: US 2024/0384105 A1
(43) Pub. Date: Nov. 21, 2024

(54) THE METHOD OF PRODUCING PIGMENT FROM FILTER SLUDGE AND ITS APPLICATION

(71) Applicant: IRONCOLOUR SP Z O.O., Ostroleka (PL)

(72) Inventors: Lukasz BOZEK, Ostroleka (PL); Arkadiusz GASINSKI, Bramki (PL); Agnieszka ANTOSIK, Warszawa (PL); Malgorzata SACZAWA, Warszawa (PL); Paulina TYMOWICZ-GRZYB, Warszawa (PL)

(21) Appl. No.: 18/695,702

(22) PCT Filed: Sep. 30, 2022
(86) PCT No.: PCT/PL2022/050060

§ 371 Date: Mar. 26, 2024

(30) Foreign Application Priority Data
Oct. 1, 2021 (PL) P.439113

(51) Int. Cl. C09C 3/00; C09C 1/00; C09C 3/04; C09C 3/10

(52) U.S. Cl. CPC C09C 3/006; C09C 1/0009; C09C 1/0081; C09C 3/043; C09C 3/10; C01P 2004/61

(57) ABSTRACT

The subject of the invention is a method for the production of pigment from filtration sludges containing manganese and iron and phosphates, characterised in that the filter sludge is sieved on a vibrating sieve, then the suspension is concentrated and dried to a water content below 8% w/w, after which the material is subjected to thermal treatment at a temperature in the range of 500-1200° C. for a period of 6-12 hours, and the obtained sinter is fragmented and optionally dried to a moisture level of 5%. The invention also relates to using the pigment produced by the foregoing method colouring construction ceramic products or as a colouring additive to the mass from which construction products are formed or as a colouring additive for concrete.

### TECHNICAL FIELD

The subject of the invention is a method of producing a pigment from filtration sludges and its use for colouring of building ceramics.

### BACKGROUND ART

A number of methods for producing pigments are known in the art. From the publication of M. H. Aly et al., Synthesis of coloured ceramic pigments by using chromite and manganese ores mixtures, Ceramica 56, 156-161 (2010), there is known a method of producing a black ceramic pigment with a spinel structure using local and inexpensive minerals, including chromite and manganese ore. The method of producing a colour pigment consisted in calcining mixtures of chromite and manganese oxide containing 30, 40 and 50% w/w manganese oxide with a low and high content, respectively. The phase composition and microstructure characteristics of both the raw material and the produced pigments were assessed and described by X-ray diffraction, X-ray fluorescence, polarization microscopy and scanning electron microscopy. It has been proven that the pigments obtained during calcination at the temperature of 1250° C. form a spinel structure of the Cr₂FeO₄ type, regardless of the composition and the mineral used. In contrast, the colour of the pigment varies from dark black to light grey depending on the content of chromite or manganese.

The publication by G. Sukmarani et al. “Synthesis of manganese ferrite from manganese ore prepared by mechanical milling and its application as an inorganic heat-resistant pigment” Journal of Materials Research and Technology 9, 4, 8497-8506 (2020) describes a method of producing a pigment with high heat resistance using calcined manganese ore and Fe₂O₃ obtained by mechanical grinding and calcination. The MnFe₂O₄ phase along with the milling process is formed at 800° C., while without the milling process, the spinel phase can be obtained at a temperature of 1000° C. Moreover, the colour measurement shows that the sample with full MnFe₂O₄ phase provides the darkest colour, while the presence of Fe₂O₃ and Mn₂O₃ leads to an increase in the brightness of the produced pigment's colour.

EP0440958B1 discloses a method of producing a black pigment consisting essentially of spinel mixed crystals of a series of magnetite-manganese ferrite mixtures. The method of producing the pigment is characterised in that iron (II) salts or mixtures of iron (II) and manganese (II) salts are oxidised in solution or after reaction with alkaline precipitants, additionally, in order to determine the iron (III) content, they are oxidised with other oxidising agents, preferably with oxygen-containing gases, and then the pigment is filtered, washed, dried and ground.

### SUMMARY OF INVENTION

The subject of the invention is a method of producing dark brown, dark grey and black pigments from filtration sludges containing manganese and iron, as well as phosphates, characterised in that the filtration sludge is sieved on a vibrating sieve with a mesh size of 100-125 μm, then the suspension is concentrated and dried to water content below 8% w/w, then the material is thermally treated at a temperature in the range of 500-1200° C. for a period of 6-12 hours, and the obtained sinter is ground and optionally dried to a moisture level of 5%. Initial screening of the filtration sludge is necessary when the sludge contains more than 2% of the sand fraction (particles with a diameter greater than 65 μm). If the amount of the aforementioned fraction is lower, then this step can be skipped.

In the process according to the invention, in order to produce a black, dark grey or dark brown pigment with the structure of iron and manganese oxides, the starting material is a waste material after deep water filtration, which is a manganese-iron suspension taken from a water treatment plant.

The granulation of the sludge affects the colour and physico-chemical properties. It is preferable to eliminate sludge fraction with a particle size in the range of 0.1-0.5 mm which is the most abundant of the quartz particles. Furthermore, the fraction below 0.1 mm disturbs the space of the desired dark pigment colours due to the high content of red hematite. Additionally, the separation of the sand fraction from the sludge prevents the formation of iron (forsterite-fayalite) and manganese silicates during the firing process (Table 1).

TABLE 1
Particle size distribution of the tested sludge
Granularity [μm]

| Dv (10) | Dv (50) | Dv (90) | Dv (99) |
|---|---|---|---|
| 3.2 | 13.1 | 50.1 | 119 |

In the method according to the invention, the sludge is dried in air and/or in a dryer, while the thermal treatment (firing) is carried out in an electric or gas furnace, wherein firing in a gas furnace is preferably performed in a reducing atmosphere. During firing, the sludge is isothermally held by maintaining the maximum temperature of the firing furnace for 1 hour.

The effect of the sludge composition, firing conditions and fragmentation on obtaining the desired colour pigment was investigated over the course of research and development.

The La*b* system was used to evaluate the colour space, where L means the brightness of the colour, and a* means the share of green or red in the analysed colour, and b* means the share of blue or yellow in the analysed colour. The results of colour tests were also presented using the CIE LC*h* standard, in which parameter L means brightness, parameter C* chromaticity according to the formula C*=√(a*2+b*2), and h* means the shade of colour according to the formula h*=arctan(b*/a*). This scale is more suitable for assessing dark pigments, the lower the C* index, the more achromatic (grey) the sample is, with lower L* brightness becoming black. Hue is the angle in the CIE LC*h* system.

A black pigment is obtained when the highest content of spinel phase (jacobsite and/or magnetite) is present.

Research works have shown that most of the spinel phase is produced when firing at 1200° C., where the chromaticity parameters (a* and b*) then decrease, but the L brightness increases slightly, making the pigment dark grey. In addition, pigments fired at this temperature are characterised by strong sintering, which makes them much more difficult to process. Lowering the calcination temperature by 100° C. to 1100° C. or less has been found to improve the grindability of the pigment. In addition, it was observed that the sediment fired at 1100° C. gave the lowest L* brightness, with only slightly enhanced C* chromaticity. On the other hand, pigments from lower temperatures (especially approx. 800° C.) already have a distinctly brown or even light brown shade. Therefore, it has been found that the preferred temperature of the method for producing black pigments from iron and manganese oxides is 1100° C.

The firing of the sludge for 6-9 h at 800° C. transforms the amorphous material into a crystalline substance with the structure of hematite and a smaller amount of magnetite (Fe₃O₄) and jacobsite (MnFe₂O₄) spinel.

Over the course of research, it was also found that better colour results for black pigment (i.e. low brightness L* and low chromaticity C*, a* and b*) and a higher proportion of spinels are observed for material fired in a gas furnace, preferably using a reducing atmosphere.

The pigment colour towards black is also improved by treating the sludge before firing, including washing the sludge and getting rid of soluble compounds, as this results in a decrease in L* brightness and C* chromaticity, and an increase in the spinel content.

Therefore, in the process according to the invention, the filtration sludge may be concentrated by adding flocculant, then filtering off the solids and washing the sludge prior to further processing.

Preferably, the desired pigment colour is obtained when the sinter formed after firing the sludge is ground into a powder, the grains of which above 22 μm constitute not more than 10% w/w, while grains with a diameter below 5 μm constitute at least 50% w/w. The fragmentation can be carried out in a wet ball mill, after which the resulting pigment is dried.

The pigment produced by the process of the invention does not contain the chromium and nickel present in commercial pigments, and is resistant to UV radiation. In addition, in the composition of the pigment produced by the method according to the invention, there are also significant amounts of phosphates, including whitlockite, which improve the mechanical resistance of the pigment-coloured product. The tests carried out confirm that in some embodiments, such as colouring a ceramic block or colouring roof tiles and clinker products, the strength parameters are improved by 1% to even 65%. For bricks, an increase in compressive strength was found from 43.85 MPa for bricks without pigment to 47.02 MPa (10% pigment content) and 50.19% (20% pigment content), while the bending strength increased for roof tiles—from 9, 1 MPa for tiles without pigment up to 12.2 MPa (5% pigment content) and 15.1 MPa (10 and 20% pigment content).

### Technical Problem

There are prior art methods for obtaining pigments based on processing sludge from deep water clarification, wherein the sludge with an iron content of at least 42% is calcined to a chocolate brown colour and then ground. Nevertheless, as it turned out, in order to ensure appropriate mechanical properties of these materials, a pigment for use in construction ceramics colouring or as a colouring additive to the mass from which construction products are formed, or as a colouring additive for concrete, must be fired at temperatures ensuring the appropriate phase composition. Calcination of the sludge, which is carried out for a total of 2 hours by gradually heating the dried iron oxide slurry to a temperature of 600° C. to obtain a chocolate brown pigment or to a temperature of 800° C. to obtain a bright red pigment and to a temperature of 1050° C. to obtain a black pigment, allows to obtain a pigment with a colour close to the desired one, but the products coloured with these colourants do not meet the strength standards. During comparative tests, a reduction in concrete strength by more than 20.5% was shown, which does not meet the requirements of PN-EN 12878, according to which the maximum reduction in concrete compressive strength should not be higher than 8% for category B pigments after 28 days.

### Solution to Problem

The pigment produced by the method according to the invention is used to colour various types of products, especially building ceramics such as roof tiles, bricks, and ceramic tiles. It is also possible to use a pigment to colour the mass from which these products are made (mass colouring), by using the pigment as a colouring additive for concrete, porcelain mass, brick mass, mass for the production of ceramic roof tiles and the like. Currently used black pigments for concretes and mortars are usually based on carbon (soot), which significantly lowers (over 10%) the mechanical strength of mortars against compression and bending. Moreover, these pigments have the disadvantage of not being resistant to UV radiation. Therefore, there is a need to develop a method of producing a pigment with increased durability and without the content of harmful additives (including nickel and chromium), which is intended for colouring construction ceramics and concrete products.

### Advantageous Effects of Invention

Surprisingly, it turned out that it was possible to produce a concrete pigment based on a mixture of carbon and the obtained spinel phases in the range of black and brown colour, and without the addition of carbon in the range of dark grey.

### BRIEF DESCRIPTION OF DRAWINGS

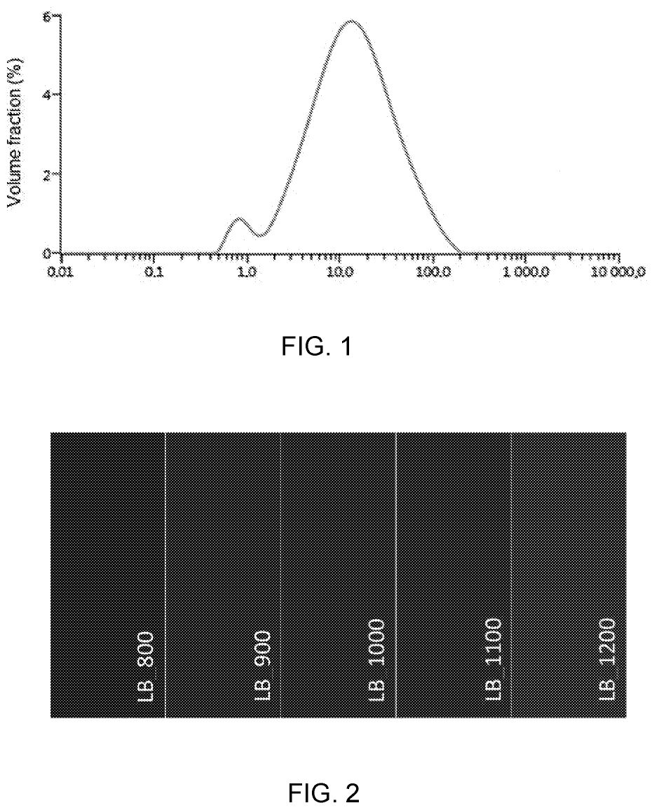

The solution according to the invention is illustrated in the figures, in which:

[FIG. 1] shows the particle size (μm) of the sludge grain;

[FIG.2] shows the representation of the colour of the pigment depending on the firing temperature. The colour of the tiles corresponds to the following colours according to the RAL palette:

LB_800, firing at the temperature of 800° C.—RAL 8016
LB_900, firing at the temperature of 900° C.—RAL 8028
LB_1000, firing at the temperature of 1000° C.—RAL 8017
LB_1100, firing at the temperature of 1100° C.—RAL 9011.

### DESCRIPTION OF EMBODIMENTS

The invention is illustrated in more detail in non-limiting examples.

### EXAMPLES

Example 1. The process was applied to the filter sludge obtained from the water treatment plant in Ciechanów with the chemical composition as in Table 2.

TABLE 2
Chemical composition of sludge obtained
from the water treatment plant in Ciechanów

| Label | Result (%) |
|---|---|
| Al₂O₃ | 0.66 |
| C | 3.00 |
| CaO | 7.20 |
| Fe | 26.16 |
| MgO | 0.31 |
| MnO | 12.41 |
| P2O5 | 2.28 |
| SiO₂ | 15.90 |
| Zn | 0.046 |

The sludge was pre-treated by sieving on a vibrating sieve with a mesh size of 125 μm in order to separate the sand fraction. Subsequently, the suspended material was subjected to the sedimentation process. Using an amount of 3% v/v flocculant (BASF's polyamine-based coagulant Magnafloc LT32) showed a positive effect in accelerating the sedimentation process in the suspension. This enabled a 68% increase in sedimentation rate using the same water to sludge ratio. For the reasons above, it can be concluded that it is preferable to add at least 3% v/v flocculant to accelerate the sedimentation process. The sludge prepared in this way, after removing the excess water, can be dried in the air until the water is completely removed from the suspension.

The sieved suspension was concentrated by sedimentation and dried to a humidity of approx. 8%. Next, the material was subjected to thermal treatment (firing) at temperatures and times as follows:
sample LB_C_800_PE—temperature 800° C., firing time 9 hours, electric furnace;
sample LB_C_900_PE—temperature 900° C., firing time 9 hours, electric furnace;
sample LB_C_1000_PE—temperature 1000° C., firing time 9 hours, electric furnace;
sample LB_C_1100_PE—temperature 1100° C., firing time 9 hours, electric furnace;
sample LB_C_1200_PE—temperature 1200° C., firing time 9 hours, electric furnace;
sample LB_C_970_PG—temperature 970° C., firing time 9 hours, gas furnace;
sample LB_C_1040_PG—temperature 1040° C., firing time 9 hours, gas furnace.

The resulting sinter was ground in a wet ball mill to a grain size of about 20μm, using selected parameters for the grinding process (pigment: grinding media ratio 1:3, pigment: water ratio 1:0.7). The grinding process ranged from 20 to 40 minutes, depending on the sample tested. The slurry was then dried at 1100° C. until the pigment grain size was obtained as shown in Table 2.

The colour parameters of the resulting powder then fit in the black range shown in Table 3.

TABLE 3
The colour of pigments - valid for
medium-grain powders as in Table 4.

| Sample | Firing | Colour parameters | | | | |
|---|---|---|---|---|---|---|
| No. | temperature (° C.) | L | a* | b* | C* | h* |
| 1 | LB_C._800_PE | 24.01 | 4.09 | 3.61 | 5.46 | 41.43 |
| 2 | LB_C._900_PE | 27.18 | 2.37 | 2.48 | 3.43 | 46.30 |
| 3 | LB_C._1000_PE | 27.42 | 2.79 | 2.25 | 3.58 | 38.88 |
| 4 | LB_C._1100_PE | 28.92 | 1.32 | 1.69 | 2.14 | 52.00 |
| 5 | LB_C._1200_PE | 32.66 | 1.13 | 1.00 | 1.51 | 41.50 |
| 6 | LB_C._970_PG | 28.27 | 3.46 | 2.82 | 4.46 | 39.18 |
| 7 | LB_C._1040_PG | 28.31 | 2.81 | 2.94 | 4.07 | 46.29 |

TABLE 4
Pigment grain size parameters

| | Firing | | | |
|---|---|---|---|---|
| Sample | temperature | Grain size parameters [μm] | | |
| No. | ° C. | D(v, 0.1) | D(v, 0.5) | D(v, 0.9) |
| 1 | LB_C_800_PE | 0.17 | 2.80 | 20.08 |
| 2 | LB_C_900_PE | 0.21 | 4.06 | 19.82 |
| 3 | LB_C_1000_PE | 0.18 | 3.14 | 15.94 |
| 4 | LB_C_1100_PE | 0.22 | 4.98 | 19.33 |
| 5 | LB_C_1200_PE | 0.27 | 4.89 | 21.25 |

Evaluation of colour parameters—The colour parameters of the pigment samples were assessed by spectrophotometry using the HunterLab MiniScan XE device, using a D65 illumination source (daylight simulation) and an observer angle of 10°. The preparation of the powder formulation consisted in pouring the opaque layer of the pigment suspension onto a flat, absorbing ceramic substrate. After drying, the colour of the obtained surface was examined. The colour tests of bricks, roof tiles and concretes were carried out on flat surfaces of the obtained shapes, it was necessary to grind the surface before testing in case of some types of concrete and ceramics.

Conclusions—In order to achieve the black colour, it is advantageous to have the highest possible content of the spinel phase (jacobsite and/or magnetite). Most of this phase is produced when firing at a temperature of 1200° C. However, at this temperature, while the chromaticity parameters (a* and b*) decrease, the brightness increases slightly, making the pigment dark grey. Furthermore, pigments fired at this temperature are characterised by strong sintering, making them much more difficult to process. Products obtained at temperatures of 1100° C. and lower are much easier to grind. In addition, the sludge fired at 1100° C. provides the lowest L* brightness, with only slightly higher C* chromaticity. Pigments from lower temperatures already have a distinctly brown shade. Based on these results, the temperature of 1100° C. was selected as the optimal temperature for obtaining black pigments from iron and manganese oxides. Comparing pigments fired in an electric and gas furnace, slightly better (more black) colours and a higher proportion of spinels were observed in case of the material fired in the gas furnace. As a result, a gas furnace can also be used to fire the pigment.

Analysis of the chemical composition of pigments

The phase composition analysis of the pigment samples is presented in Table 5.

TABLE 5
Phase composition of pigments sintered at different temperatures.

| Temperature ° C. | spinel | hematite | whitlockite | quartz | cristobalite |
|---|---|---|---|---|---|
| LB_C_800_PE | 33.60 | 50.36 | 4.93 | 3.94 | — |
| LB_C_900_PE | 15.18 | 63.96 | 6.53 | 6.13 | 0.75 |
| LB_C_1000_PE | 22.18 | 51.22 | 9.50 | 6.87 | 3.13 |
| LB_C_1100_PE | 29.76 | 45.19 | 12.11 | 4.29 | 2.49 |
| LB_C_1200_PE | 50.17 | 27.23 | 12.81 | 1.12 | 1.90 |
| LB_C_970_PG | 43.22 | 38.52 | 6.21 | 4.39 | 2.65 |
| LB_C_1040_PG | 56.59 | 17.86 | 13.19 | 4.72 | 0.58 |

Example 2. The process was applied to the filter sludge obtained from the Knurów-Szczygłowice Coal Mine, Poland, with the chemical composition as in Table 6.

TABLE 6
Chemical composition of the sludges
obtained from the Knurów-Szczygłowice
Coal Mine, Poland.

| Label | Result (%) |
|---|---|
| Al₂O₃ | 1.43 |
| C | 1.88 |
| CaO | 4.36 |
| Fe | 30.56 |
| MgO | 0.22 |
| MnO | 3.74 |
| P2O5 | 1.92 |
| SiO₂ | 28.41 |
| Zn | 0.016 |

The sludge was pre-treated by sieving on a vibrating sieve with a mesh size of 125 μm in order to separate the sand fraction. Subsequently, the suspended material was subjected to the sedimentation process. A flocculant (a coagulant called Magnafloc LT32 from BASF based on polyamine) was used in the amount of 3% v/v The screened suspension was concentrated by sedimentation and dried to a moisture content of approx. 6%. Next, the material was subjected to thermal treatment (firing) at the following temperatures:
sample LB_K_800—at 800° C. for 7 hours;
sample LB_K_1100—at 1100° C. for 7 hours.

Each of the obtained sinters a) and b) was ground in a wet ball mill to a grain size of about 20 μm, using selected parameters for the grinding process (pigment: grinding media ratio 1:3, pigment: water ratio 1:0.7). The grinding process was performed for 30 minutes. Next, the suspension was dried at the temperature of 1100° C.

Example 3. The process was applied to the filter sludge obtained from the water treatment plant in Pułtusk, Poland with the chemical composition as in Table 7.

TABLE 7
Chemical composition of sludge obtained
from the water treatment plant in Pułtusk, Poland.

| Label | Result (%) |
|---|---|
| Al₂O₃ | 2.41 |
| C | 5.36 |
| CaO | 5.01 |
| Fe | 43.15 |
| MgO | 0.93 |
| MnO | 1.49 |
| P2O5 | 2.12 |
| SiO₂ | 7.28 |
| Zn | 0.023 |

The sludge was pre-treated by sieving on a vibrating sieve with a mesh size of 125 μm in order to separate the sand fraction. Subsequently, the suspended material was subjected to the sedimentation process. A flocculant (a coagulant called Magnafloc LT32 from BASF based on polyamine) was used in the amount of 3% v/v The screened suspension was concentrated by sedimentation and dried to a moisture content of approx. 7%. Next, the material was subjected to thermal treatment (firing) at the following temperatures:
sample LB_P_800—at 800° C. for 8 hours;
sample LB_P_1100—at 1100° C. for 8 hours.

Each of the obtained sinters a) and b) was ground in a wet ball mill to a grain size of about 20 μm, using selected parameters for the grinding process (pigment: grinding media ratio 1:3, pigment: water ratio 1:0.7). The grinding process was performed for 30 minutes. Next, the suspension was dried at the temperature of 1100° C.

Example 4. Testing the mechanical strength of concrete coloured with black pigment

In accordance with the PN-EN 12878 standard, for category B, the compressive strength after 28 days should not be reduced by more than 8% compared to the mixture with no pigment. As a standard, iron oxides and/or modified carbon black are used to colour concrete black. Carbon black, however, reduces its mechanical strength. The tests were carried out using concrete with the addition of 5% w/w. black pigment, sintered at a temperature of 1100° C., prepared on the basis of filtration sludges obtained from:
water treatment plant in Ciechanów, Poland (sample: LB_C_1100_5%);
Knurów-Szczygłowice Coal Mine, Poland (sample: LB_K_1100_5%);
water treatment plant in Pułtusk, Poland (sample: LB_P_1100_5%).

In addition, a mixture of pigment prepared on the basis of filter sludge from the water treatment plant in Ciechanow (LB_C_1100_5%) with modified carbon black (CB) was tested at a ratio of CB: LB_C_1100_5% 1:3, CB: LB_C_1100_5% 1:2 and CB: LB_C_1100_5% 1:1. The results of the test are presented in Table 8.

TABLE 8
The results of the compressive strength test
of pigment-coloured concrete (mean of 6 tests)

| | Compressive | Standard | Strength |
|---|---|---|---|
| | strength | deviation | increase |
| Sample No._% % w/w | [MPa] | [MPa] | [%] |
| Reference | 48.2 | 0.89 | 0.00 |
| LB_C_1100_5% | 49.4 | 1.02 | 2.45 |
| LB_K_1100_5% | 49.1 | 0.99 | 1.87 |
| LB_P_1100_5% | 49.2 | 0.96 | 2.07 |
| CB:LB_C_1100_5% 1:3 | 47.5 | 1.49 | −1.62 |
| CB:LB_C_1100_5% 1:2 | 47.2 | 0.93 | −2.23 |
| CB:LB_C_1100_5% 1:1 | 46.3 | 0.87 | −4.11 |
| CB_326_2% | 38.1 | 1.15 | −21.11 |

Concrete samples coloured with the pigment obtained by the method according to the invention have an increased compressive strength. As can be seen, increasing the amount of carbon black in the pigment reduces the strength. The tests showed that the concrete stained with carbon black N326 (sample: CB_326_2%) achieved the compressive strength at an average level of 38.1 MPa, which meant a decrease in strength by 21.11% compared to the reference sample without pigment.

Example 5. Testing the mechanical strength of pigment-coloured brick mass.

The preparation of test samples started with the preparation of proglacial clay mass. The dry material was crushed and soaked in plenty of water to homogenize it. After the slurry was homogenised, its humidity was adjusted to a level that would enable achieving plastic properties allowing shape formation. The mass was divided into 7 parts and the pigment was added to each of them as indicated in Table 8, except for the mass I, which did not contain added pigment. as a reference sample. The research was carried out using a pigment prepared on the basis of filter sludge obtained from:
water treatment plant in Ciechanów, Poland (sample: LB_C_1100),
Knurów-Szczygłowice Coal Mine, Poland (sample: LB_K_1100),
water treatment plant in Pułtusk, Poland (sample: LB_P_1100).

Table 8 shows the results of the compressive strength tests for the tested materials. It is a key parameter when assessing the suitability the material in construction applications. It was observed that the compressive strength increases along with hematite-spinel pigment share. In addition, the materials with added pigment obtained by the process according to the invention demonstrate significantly higher shrinkage after firing, indicating that pigment addition also contributes to greater sintering of the product, consequently providing increased compressive strength parameters.

TABLE 9
Moisture after forming, firing shrinkage and compressive
strength for proglacial clay with different amounts of pigment

| Mass determination | | | |
|---|---|---|---|
| (pigment | Moisture | | |
| content: | after | Firing | Compressive |
| % w/w_sample | forming | shrinkage | Strength |
| number) | (%) | (%) | (MPa) |
| I (no pigment) | 21.3 | 0 | 43.85 |
| P1 (10% LB_C_1100) | 22.4 | 0.9 | 47.02 |
| P2 (10% LB_K_1100) | 22.4 | 0.9 | 46.11 |
| P3 (10% LB_P_1100) | 22.3 | 0.9 | 46.68 |
| T1 (20% LB_1100) | 19.9 | 1 | 50.19 |
| T2 (20% LB_K_1100) | 19.8 | 1 | 49.22 |
| T3 (20% LB_P_1100) | 19.9 | 1 | 49.75 |

Example 4. Testing water permeability and mechanical strength of pigment-coloured ceramic roof tiles

The raw material from the Pałęgi mine located in the Świętokrzyskie Voivodeship in Poland was used to carry out the research on the ceramic tile mass. The “Pałęgi” deposit is made of Lower Triassic mudstones and claystones of cherry-red to dark brown colour with aquamarine spots and streaks. Thanks to its chemical and mineral composition, as well as technological properties, it is a raw material for the production of ceramic products, such as roof tiles or facade bricks and clinker tiles.

The research was carried out using a pigment prepared on the basis of filter sludge obtained from:
water treatment plant in Ciechanów, Poland (sample: LB_C_1100),
Knurów-Szczygłowice Coal Mine, Poland (sample: LB_K_1100),
water treatment plant in Pułtusk, Poland (sample: LB_P_1100).

Water was added to the mass from the “Pałegi” deposit, which made the mass more plastic. The mass was then divided into 10 equal parts to which the pigment was added as specified in Table 9, except for the mass I, which did not contain added pigment, as a reference.

Shapes were formed from the masses prepared in this way with different pigment content (0%, 5%, 10% and 20%), which were then dried and fired in a chamber furnace and then cooled to room temperature. Before the water absorption test, the fired roof tiles were immersed in water for 48 hours, then dried at 105° C. to a constant weight, and cooled to room temperature.

The water permeability test was carried out according to the method, which consists in determining the time from the start of the test until the first drop falls from the bottom surface of the tile under the influence of the pressure of a 60 mm high water column exerted on the top surface of the tile. The maximum duration of the test is 20 hours.

No drop of water fell for 20 hours for all tested tiles. After a few (5-7) hours from the start of the test, the appearance of moisture on the lower surface of the tiles was observed throughout the test, but it did not cause water leakage and condensation. All roof tiles can be classified as category I according to PN-EN 539-1:2007, because they have a water permeability coefficient [cm\hat{ }3/(cm\hat{ }2*day)]≤0.8.

Next, a bending load test was carried out for the roof tiles prepared identically as those used in the water absorption test.

The bending resistance test consists in placing the tile on two supports spaced two-thirds of the tile's length apart and applying the load F from the top to the entire width of the tile in the middle between the supports. The distance between the supports was 120 mm. The tested roof tiles are deemed to meet the requirements if, when subjected to bending load, they will not break under the load F of not less than: 600 N—flat tiles (plain tiles);
900N—tiles with longitudinal and transverse locks, with a flat face surface;
1000N—monk and nun tiles;
1200N—other tiles.

The results are presented in Table 10.

TABLE 10
Measurement results for the resistance to bending
for roof tiles with different LB_1100 pigment content

| | Breaking | Bending |
|---|---|---|
| | load | strength |
| Sample symbol | F[N] | [MPa] |
| P (no pigment) | 1,116.71 | 9.1 |
| P (5% LB_C_1100) | 1,330.41 | 12.2 |
| P (5% LB_K_1100) | 1,301.26 | 12.1 |
| P (5% LB_P_1100) | 1,318.75 | 12.2 |
| P (10% LB_C_1100) | 1,782.98 | 15.2 |
| P (10% LB_K_1100) | 1,730.89 | 15.1 |
| P (10% LB_P_1100) | 1,768.12 | 15.1 |
| P (20% LB_C_1100) | 1,793.51 | 15.2 |
| P (20% LB_K_1100) | 1,738.29 | 15.1 |
| P (20% LB_P_1100) | 1,776.32 | 15.2 |

Conclusions—For samples coloured in a mass using pigments according to the invention, a significant improvement in the bending strength of 33-67% was observed, compared to the sample with no pigment.

The pigment produced by the process according to the invention differs in terms of chemical composition. In addition to the crystalline phases, i.e. magnetite and jacobsite, phosphates have quite significant share in the pigment, including crystalline whitlockite, which has cementing properties. The greater the proportion of whitlockite in the pigment, the better the mechanical resistance of the product coloured with such a pigment. In addition, whitlockite has the share of iron and manganese, which changes its colour to a darker and does not deteriorate the intensity of the pigment.

Example 5. Testing the mechanical strength of concrete coloured with black pigment (comparative example).

In order to demonstrate the effect of the pigment obtained by the method according to the invention, the pigment was prepared with a method other than one according to the invention, and strength tests were subsequently carried out.

Sludge from deep water filtration with an iron content of min. 42% was dried to a water content of 8%, and then subjected to graded sintering at temperatures of 800° C. for 2 hours (pigment A), 600° C. for 1.7 hours (pigment B), 1050° C. for 2.3 hours, respectively (pigment C). The following pigments were obtained: pigment A—light red colour, pigment B—brown colour, pigment C—dark grey colour.

Next, each of the sinters (A-C pigments) was ground in a wet ball mill to a grain size of about 20 μm, using selected parameters for the grinding process (pigment: grinding media ratio 1:3, pigment: water ratio 1:0.7). The grinding process was performed for 30 minutes. The slurry was then dried at 110° C.

Mass-coloured concrete samples were prepared as described in Example 4, using pigments A-C and with pigment.

The compressive strength test was carried out 28 days after the samples were produced, in accordance with the PN-EN 12878 standard. The result is shown in Table 11.

TABLE 11
Results of durability tests

| | Compressive | |
|---|---|---|
| | strength | Strength |
| | [MPa] | decrease |
| Specimen | [after 28 days] | [%] |
| Concrete coloured with 4% | 40.7 | 15.56 |
| pigment a) | | |
| Concrete coloured with 4% | 33.6 | 30.29 |
| pigment b) | | |
| Concrete coloured with 4% | 42.5 | 11.82 |
| pigment c) | | |
| Uncoloured concrete | 48.2 | 0 |
| Concrete coloured with 5% | 49.4 | −2.45 |
| LB_1100 pigment | | |

Conclusions—Concrete coloured with A-C pigments showed a very clear reduction in compressive strength 28 days after forming. The obtained compressive strength results are worse even in relation to a sample of uncoloured concrete. This means that concrete coloured with such pigments does not even qualify as the “B” category, therefore its quality would be very low and of little use in commercial conditions. Interestingly, the greatest reduction in strength was shown by concrete coloured with pigment B, i.e. sintered at the lowest temperature. Moreover, the strength parameters improved for a concrete sample coloured with a pigment resulting from sludge processing according to the invention in example 3, with an iron content of 43.15%, pigment T1 (20% LB_1100), 28 days after concrete sample formation.

The obtained results prove that the pigments produced with the method according to the invention have a beneficial effect on improving the strength parameters of concrete and ceramic products coloured with these pigments, not only immediately after their preparation, but also during storage.

### Patent Literature

PTL1: Patent EP0440958B1

Non Patent Literature

NPL1: M. H. Aly at al., Synthesis of coloured ceramic pigments by using chromite and manganese ores mixtures, Ceramica 56, 156-161 (2010)

NPL2: G. Sukmarani at al. “Synthesis of manganese ferrite from manganese ore prepared by mechanical miling and its application as an inorganic heat-resistant pigment” Journal of Materials Research and Technology 9, 4, 8497-8506 (2020)

1. A method for producing a pigment from a waste material after deep water filtration, which is a manganese-iron suspension taken from a water treatment plant containing manganese and iron, and phosphates, characterised in that the manganese-iron suspension has a dry matter content of at least 15% w/w iron compounds and/or at least 0.5% w/w manganese compounds and/or 0.5% w/w phosphorus compounds is sieved on a vibrating sieve with a mesh size of 100-125 μm, then the suspension is concentrated and dried to a water content of less than 8% w/w, and then the material is subjected to thermal treatment at a temperature in the range of 500-1200° C. for a period of 6-12 hours, and the obtained sinter is ground and optionally dried to a moisture level of 5%.

2. The method according to claim 1, characterised in that thickening of the manganese-iron suspension is carried out by adding a flocculant, then filtering off the solids and washing the sludge before further treatment or by sedimentation.

3. The method according to claim 1, characterised in that drying of the manganese-iron suspension is carried out in air and/or in a dryer.

4. The method according to claim 1, characterised in that the thermal treatment is carried out in an electric or gas furnace, the firing in the gas furnace preferably being carried out in a reducing atmosphere.

5. The method according to claim 4, characterised in that during the firing, the manganese-iron suspension is subjected to isothermal holding by maintaining the maximum temperature of the firing furnace for 1 hour.

6. The method according to claim 1, characterised in that the sinter is fragmented into a powder, wherein the grains with a size greater than 22 μm constitute not more than 10% w/w, and grains with a diameter below 5 μm constitute at least 50% w/w.

7. (canceled)

8. Use of the pigment produced by a method as described in claim for colouring construction ceramics or as a colouring additive to the mass from which construction products are formed, or as a colouring additive for concrete.
